(19) United States
(12) Patent Application Publication
(10) Pub. No.: US 2024/0139710 A1
(43) Pub. Date: May 2, 2024

(54) SORBENT POLYMER COMPOSITE ARTICLE FOR ADSORPTION

(71) Applicant: W. L. Gore & Associates, Inc., Newark, DE (US)

(72) Inventors: Edward H. Cully, Newark, DE (US); Christine M. Scotti, Newark, DE (US)

(21) Appl. No.: 18/280,398

(22) PCT Filed: Mar. 7, 2022
(86) PCT No.: PCT/US2022/019116

§ 371 Date: Sep. 5, 2023

Related U.S. Application Data
(60) Provisional application No. 63/302,847, filed on Jan. 25, 2022.
(60) Provisional application No. 63/157,426, filed on Mar. 5, 2021.

(51) Int. Cl. B01J 20/26; B01D 53/02; B01J 20/28; B01J 20/32

(52) U.S. Cl. CPC B01J 20/261; B01D 53/02; B01J 20/28035; B01J 20/3204; B01J 20/3272; B01D 2253/202; B01D 2253/25; B01D 2253/304; B01D 2257/504

(57) ABSTRACT

A sorbent polymer composite article is disclosed for adsorption. The sorbent polymer composite article includes a composite layer comprising a porous polymer and a sorbent material. The sorbent polymer composite article also includes at least one hydrophobic layer on either side of the first composite region.

### CROSS-REFERENCE TO RELATED APPLICATIONS

This application is a national phase application of PCT Application No. PCT/US2022/019116, internationally filed on Mar. 7, 2022, which claims priority to U.S. Provisional Application No. 63/157,426, filed on Mar. 5, 2021, and U.S. Provisional Application No. 63/302,847, filed on Jan. 25, 2022, the disclosure of each application being hereby incorporated herein by reference in its entirety.

### FIELD

The present disclosure relates to a sorbent polymer composite article, methods of forming a sorbent polymer composite article, and methods of using a sorbent polymer composite article for the purpose of adsorption, including adsorption for direct air capture (DAC) of carbon dioxide.

### BACKGROUND

Increasing carbon dioxide (CO₂) levels associated with greenhouse gas emissions are shown to be harmful to the environment. As reported by the Climate.gov article “Climate Change: Atmospheric Carbon Dioxide,” the 2019 average carbon dioxide level in the atmosphere was 409.8 ppm, the highest level that has been noted in the past 800,000 years. The rate of increase of CO₂ in the atmosphere is also much higher than the rates in previous decades.

In order to limit the impact of climate change, it is not only necessary to reduce CO₂ emissions in the near future to zero but also to achieve negative CO₂ emissions. Several possibilities exist in order to achieve negative emissions, e.g. combustion of biomaterials for the generation of electricity combined with CO₂ capture from the combustion flue gas and subsequent CO₂ sequestration (“BECCS”) or direct air capture of CO₂ (“DAC”).

Gas separation by adsorption has many different applications in industry, for example removing a specific component from a gas stream, where the desired product can either be the component removed from the stream, the remaining depleted stream, or both. Thereby, both trace components as well as major components of the gas stream can be targeted by the adsorption process. One important gas separation application is in capturing CO₂ from gas streams, e.g., from flue gases, exhaust gases, industrial waste gases, biogas or atmospheric air. Atmospheric air is considered a dilute feed stream of CO₂.

Capturing CO₂ directly from the atmosphere, referred to as DAC, is one of several means of mitigating anthropogenic greenhouse gas emissions and has attractive economic prospects as a non-fossil, location-independent CO₂ source for the commodity market and for the production of synthetic fuels. The specific advantages of CO₂ capture from the atmosphere include: a) DAC can address the emissions of distributed sources (e.g. vehicles . . . land, sea and air), which account for a large portion of the worldwide greenhouse gas emissions and can currently not be captured at the site of emission in an economically feasible way; b) DAC can address legacy emissions and can therefore create truly negative emissions, and c) DAC systems do not need to be attached to the source of emission but may be location independent and can be located at the site of further CO₂ processing or usage.

There is increasing motivation to develop and improve upon these processes to make them more efficient, maximizing the amount of CO₂ removed from the atmosphere while minimizing the energy required in the process.

FIG. 1 is a schematic diagram of the process involved in a traditional DAC system 10. An input feed stream 11 is provided, containing a mixture of CO₂ molecules 16 in a non-CO₂ diluent 18. For example, the input feed stream 11 may be an air stream. During an adsorption process, the input feed stream 11 is exposed to an adsorbent 12. The CO₂ molecules 16 adsorb onto the adsorbent 12, while the non-CO₂ diluent 18 passes the adsorbent 12 and is exhausted from the system 10. The adsorbent 12 then undergoes a process of desorption in order to release the CO₂ molecules 16 from the adsorbent 12. The desorption process may involve moisture in the form of liquid water or steam or changes in the system temperature through reactions or energy delivered to the system. This desorption process is referred to as a “swing” adsorption to define the cyclic process of repeatedly adsorbing and desorbing of CO₂. If moisture swing adsorption is being used, the adsorbent 12 may be exposed to moisture in the form of water vapor or liquid water to cause the desorption of the CO₂ molecules 16. If temperature swing adsorption is being used, heat may be applied to the adsorbent 12 to cause desorption of the CO₂ molecules 16. These moisture and/or temperature swings temporarily break the bonds that retain the molecules to the adsorbent 12 so that the CO₂ molecules 16 can be released. The desorbed CO₂ molecules 16 are thus separated from the adsorbent 12 and collected as the output 14. The collected CO₂ molecules 16 can then be concentrated and subjected to further necessary processes before being used or stored. It is important that the adsorbent 12 used is able to repeatedly withstand the environments necessary for separating the CO₂ molecules 16, such as high temperatures and high moisture conditions.

There are established articles and techniques for DAC. An example is using an article including a substrate such as a monolith that supports or is coated with a sorbent material. Variations are established by changing the type of substrate and the sorbent that is used. However, these previously established articles and methods present limitations in the ability to efficiently cycle between adsorbing and desorbing states. They also have limitations with respect to the durability of the article. The articles may also degrade when exposed to high temperatures or high moisture level environments, or combinations thereof, which can result in a shorter lifetime.

### SUMMARY

A sorbent polymer composite article is disclosed for adsorption, including adsorption for DAC. The sorbent polymer composite article includes a composite layer comprising a porous polymer and a sorbent material. The sorbent polymer composite article also includes at least one hydrophobic layer on either side of the first composite layer.

According to one example (“Example A”), a sorbent polymer composite article includes a first composite region including a first porous polymer and a sorbent material, the first composite region having a first hydrophobicity, and a second region of a second porous polymer positioned adjacent to a first side of the first composite region, the second region having a second hydrophobicity that exceeds the first hydrophobicity.

According to a second example (“Example B”), a method of forming a sorbent polymer composite article includes the steps of forming a first composite region comprising a first porous polymer and a sorbent material, and forming a second hydrophobic region comprising a second porous polymer on a first side of the first composite region.

According to a third example (“Example C”), a method of using a sorbent polymer composite article for adsorption includes the steps of providing a sorbent polymer composite article includes a first composite region having a first porous polymer and a sorbent and having a first hydrophobicity, and a second region positioned adjacent to a first side of the first region and having a second hydrophobicity that exceeds the first hydrophobicity, directing a feed stream including carbon dioxide across the sorbent polymer composite article, and adsorbing the carbon dioxide into the sorbent polymer composite article.

According to a fourth example (“Example D”), a sorbent polymer composite article includes a first region having a sorbent material and a screen, a second region including a second polymer positioned adjacent the first region, and a third region including a third polymer positioned adjacent the first region.

According to a fifth example (“Example E”), a sorbent polymer composite article includes a first composite region having a first porous polymer and a sorbent material, the first composite region having a first hydrophobicity, a second region of a second porous polymer positioned adjacent to a first side of the first composite region, the second region having a second hydrophobicity that exceeds the first hydrophobicity, a third region of a third porous polymer positioned adjacent to a second side of the first composite region, the third region having a third hydrophobicity that exceeds the first hydrophobicity, and an end-sealing region disposed to encompass an end of the first composite region between the second and third regions.

### BRIEF DESCRIPTION OF THE DRAWINGS

FIG. 1 is a schematic diagram of the process involved in a DAC process.

FIG. 2 is an elevational view of a first sorbent polymer composite article of the present disclosure.

FIG. 2A is a schematic elevational view of the first composite region of the first composite article of FIG. 2.

FIG. 2B is a schematic elevational view of the first composite region of a compressed form of the first composite article of FIG. 2.

FIG. 2C is a schematic elevational view of the first composite region of a further compressed form of the first composite article of FIG. 2B.

FIG. 2D is an elevational view of the first sorbent polymer composite article of FIG. 2 illustrated with an end-sealing region of the present disclosure.

FIG. 3 is a flowchart illustrating a method of forming the sorbent polymer composite article of FIG. 2.

FIG. 4 is an elevational view of a second sorbent polymer composite article of the present disclosure.

FIG. 5 is a flowchart illustrating a method of forming the sorbent polymer composite article of FIG. 4.

FIG. 6 is an elevational view of a third sorbent polymer composite article of the present disclosure.

FIG. 7 is a flowchart illustrating a method of forming the sorbent polymer composite article of FIG. 6.

FIG. 8 is a flowchart illustrating a method of using embodiments of a sorbent polymer composite article in accordance with the present disclosure.

FIG. 9A is an elevational view of a fourth sorbent polymer composite article of the present disclosure.

FIG. 9B is an elevational view of a variation of the sorbent polymer composite article of FIG. 9A.

FIGS. 10A, 10B, 10C, and 10D are scaled SEM images illustrating an example of a sorbent polymer composite article in accordance with the present disclosure.

FIGS. 11A, 11B, 11C, and 11D are scaled SEM images illustrating an example of a sorbent polymer composite article, in accordance with the present disclosure.

FIG. 12 is a chart displaying CO₂ adsorption results consistent with testing procedures conducted on samples formed in Examples 4, 5a, 5b and 6.

FIG. 13 is a chart displaying CO₂ adsorption kinetic results consistent with testing procedures conducted on samples formed in Examples 4, 5a, 5b, and 6.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

The term “fibril” as used herein describes an elongated piece of material such as a polymer, where the length and width are substantially different from each other. For example, a fibril may resemble a piece of string or fiber, where the width (or thickness) is much shorter or smaller than the length.

The term “node” as used herein describes a connection point of at least two fibrils, where the connection may be defined as a location where the two fibrils come into contact with each other, permanently or temporarily. In some examples, a node may also be used to describe a larger volume of polymer than a fibril and where a fibril originates or terminates with no clear continuation of the same fibril through the node. In some examples, a node has a greater width but a smaller length than the fibril.

As used herein, “nodes” and “fibrils” may be used to describe objects that are usually, but not necessarily, connected or interconnected, and have a microscopic size, for example. A “microscopic” object may be defined as an object with at least one dimension (width, length, or height) that is substantially small such that the object or the detail of the object is not visible to the naked eye or difficult, if not impossible, to observe without the aid of a microscope (including but not limited to a scanning electron microscope or SEM, for example) or any suitable type of magnification device.

### DESCRIPTION OF VARIOUS EMBODIMENTS

The present disclosure relates to a sorbent polymer composite article, methods of forming a sorbent polymer composite article, and methods of using a sorbent polymer composite article to adsorb and separate one or more desired substances from a source stream. While the sorbent polymer composite article is described below for use in the capture of CO₂ from a dilute feed stream, such as air, it may also be used in other adsorbent methods and applications. These methods include, but are not limited to, adsorption of substances from various inputs, including other gas feed streams (e.g., combustion exhaust) and liquid feed streams (e.g., ocean water). The adsorbed substance is not limited to CO₂. Other adsorbed substances may include, but are not limited to, other gas molecules (e.g., N₂, CH₄, and CO), liquid molecules, and solutes. In certain embodiments, the input may be dilute, containing on the order of parts per million (ppm) of the desired substance.

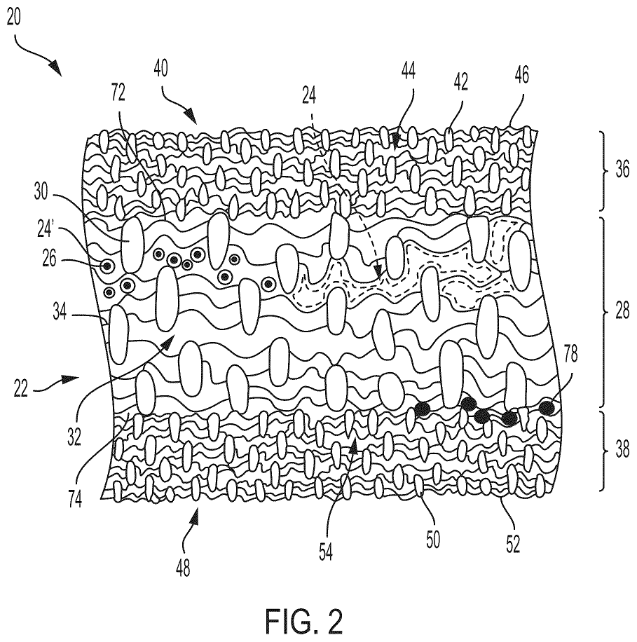

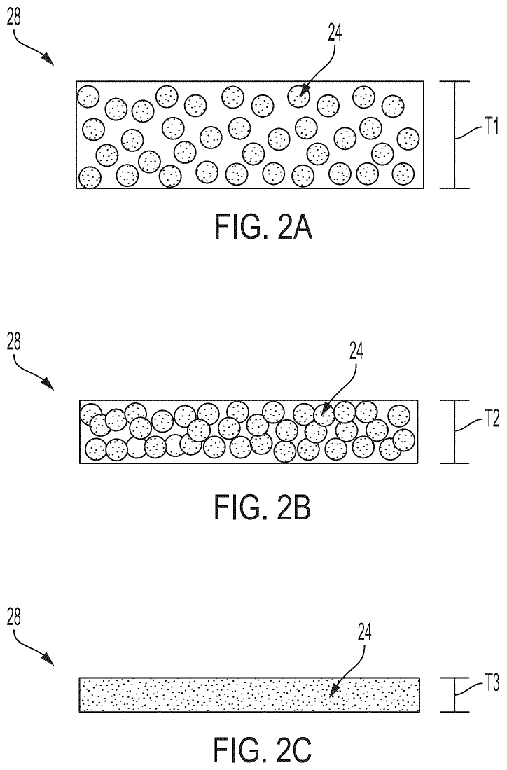

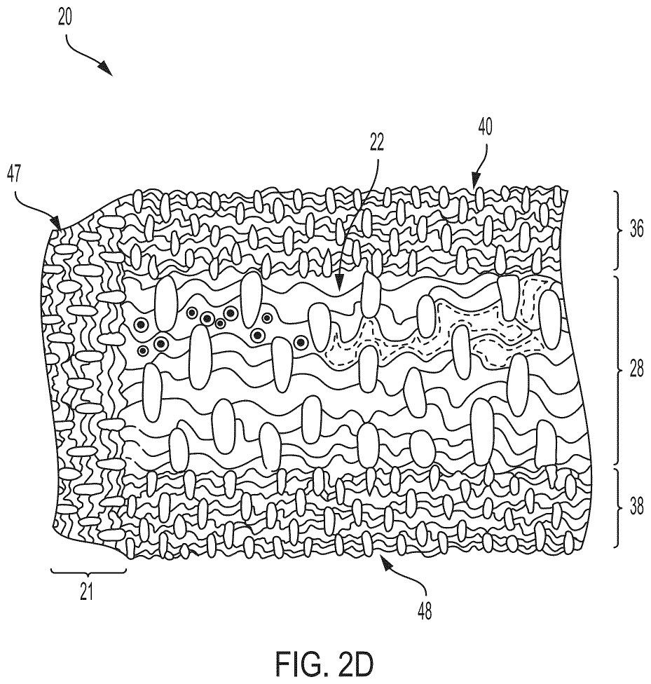

FIG. 2 shows a first exemplary sorbent polymer composite article 20 of the present disclosure including a first composite region 28. The first composite region 28 includes a first porous polymer 22 and a sorbent material 24, 24′. The first composite region 28 may also include an optional carrier 26. Each element of the first composite region 28 is described further below.

The first porous polymer 22 of the first composite region 28 may be one of expanded polytetrafluoroethylene (ePTFE), expanded polyethylene (ePE), polytetrafluoroethylene (PTFE), or another suitable porous polymer. It will be appreciated that non-woven materials such as nanospun, meltblown, spunbond and porous cast films could be among the various other suitable porous polymer forms. The first porous polymer 22 may be expanded by stretching the polymer at a controlled temperature and a controlled stretch rate, causing the polymer to fibrillate. Following expansion, the first porous polymer 22 may comprise a microstructure of a plurality of nodes 30 and a plurality of fibrils 34 that connect adjacent nodes 30. In these instances, the first porous polymer 22 includes pores 32 bordered by the fibrils 34 and the nodes 30. An exemplary node and fibril microstructure is described in U.S. Pat. No. 3,953,566 to Gore, incorporated herein by reference in its entirety. The pores 32 of the first porous polymer 22 may be considered micropores. Such micropores may have a single pore size or a distribution of pore sizes. The average pores size may range from 0.1 microns to 100 microns in certain embodiments.

The sorbent material 24, 24′ of the first composite region 28 is a substrate having a surface configured to hold the desired substance from the input on the surface via adsorption. The sorbent material 24, 24′ varies based on which substances are targeted for adsorption. In various embodiments, the sorbent material 24, 24′ is a carbon dioxide adsorbing material which may include, but is not limited to, an ion exchange resin (e.g., a strongly basic anion exchange resin such as Dowex™ Marathon™ A resin available from Dow Chemical Company), zeolite, activated carbon, alumina, metal-organic frameworks, polyethyleneimine (PEI), desiccant, carbon molecular sieve, carbon adsorbent, graphite, activated alumina, molecular sieve, aluminophosphate, silicoaluminophosphate, zeolite adsorbent, ion exchanged zeolite, hydrophilic zeolite, hydrophobic zeolite, modified zeolite, natural zeolites, faujasite, clinoptilolite, mordenite, metal-exchanged silico-aluminophosphate, uni-polar resin, bi-polar resin, aromatic cross-linked polystyrenic matrix, brominated aromatic matrix, methacrylic ester copolymer, graphitic adsorbent, carbon fiber, carbon nanotube, nano-materials, metal salt adsorbent, perchlorate, oxalate, alkaline earth metal particle, ETS, CTS, metal oxide, chemisorbent, amine, organo-metallic reactant, hydrotalcite, silicalite, zeolitic imadazolate framework and metal organic framework (MOF) adsorbent compounds, and combinations thereof.

The sorbent material 24, 24′ may be present in the first porous polymer 22 as a coating, a filling, entrained particles, and/or in another suitable form, as described further below. In the illustrated embodiment of FIG. 2, the first porous polymer 22 is coated with the sorbent material 24, such that the sorbent material 24 forms a substantially continuous coating on the nodes 30 and/or fibrils 34 of the first porous polymer 22. It is also within the scope of the present disclosure for the first porous polymer 22 to be filled with the sorbent material 24, such that the sorbent material 24 is incorporated into the nodes 30 and/or fibrils 34 of the first porous polymer 22. In the illustrated embodiment of FIG. 2, the particles of the sorbent material 24 on the carrier 26 are entrained in the first porous polymer 22, such that the sorbent material 24′ occupies the pores 32 between the nodes 30 and fibrils 34 of the first porous polymer 22.

The optional carrier 26 of the first composite region 28 is a material that is configured to increase the surface area of the region it occupies which may allow for an increased surface area that is available for adsorption of the desired substance. The carrier 26 may include a mesoporous silica, polystyrene beads, porous polymeric bed or sphere, oxide supports, another suitable carrier material. The carrier 26 may further include a porous film comprising porous inorganic materials within it such as calcium sulfate, alumina, activated charcoal and fumed silica. As noted above, the carrier 26 may be present in the pores 32 of the first composite region 28 as high surface area particles that are coated or functionalized with the sorbent material 24′. The combination of the carrier 26 coated with the sorbent material 24′ increases the surface area available for adsorption. In these embodiments, the nodes 30 and fibrils 34 may or may not be coated with sorbent material 24. When the nodes 30 and fibrils 34 are not coated, the original hydrophobicity of the first porous polymer 22 may be retained.

The first composite region 28 of the sorbent polymer composite article 20 includes a first side 72 (e.g., an upper side in FIG. 2) and a second side 74 (e.g., a lower side in FIG. 2). The sorbent polymer composite article 20 further includes a second region 36 comprising a second porous polymer 40, where the second region 36 is positioned adjacent to the first side 72 of the first composite region 28. In various embodiments, the sorbent polymer composite article also includes a third region 38 comprising a third porous polymer 48, where the third region 38 is positioned adjacent to the second side 74 of the first composite region 28. In this way, the first composite region 28 may be sandwiched between the second layer 36 on the first side 72 and the third layer 38 on the second side 74. The second porous polymer 40 of the second region 36 may comprise a plurality of nodes 42, a plurality of fibrils 46 that connect adjacent nodes 42, and a plurality of pores 44 that are each formed between the respective nodes 42 and fibrils 46. Similarly, the third porous polymer 48 of the third region 38 may comprise a plurality of nodes 50, a plurality of fibrils 52 that connect adjacent nodes 50, and a plurality of pores 54 formed between the respective nodes 50 and fibrils 52. The pores 44 of the second porous polymer 40 and/or the pores 54 of the third porous polymer 48 may be considered micropores, as described further above.

The first composite region 28, the second region 36, and the third region 38 of the sorbent polymer composite article 20 may be formed using different processes. In certain embodiments, the first composite region 28, the second region 36, and/or the third region 38 may be formed as discrete layers and then coupled together. In this case, the first porous polymer 22 of the first composite region 28, the second porous polymer 40 of the second region 36, and/or the third porous polymer 48 of the third region 38 may be distinct structures. In other embodiments, the first composite region 28, the second region 36, and/or the third region 38 may be formed together and then subjected to different coating processes or surface treatments, as described further below, to differentiate certain regions. In this case, the first porous polymer 22 of the first composite region 28, the second porous polymer 40 of the second region 36, and/or the third porous polymer 48 of the third region 38 may be continuous or integrated structures.

The first composite region 28, the second region 36, and the third region 38 of the sorbent polymer composite article 20 may have differing degrees of hydrophobicity. The hydrophobicity may be altered through various methods, such as through applying coatings or surface treatments which can include, but are not limited to, plasma etching and applying micro-topographical features. The first composite region 28 has a first hydrophobicity, the second region 36 may have a second hydrophobicity, and the third region 38 may have a third hydrophobicity. The first hydrophobicity is less than that of each the second hydrophobicity and the third hydrophobicity. The second hydrophobicity may be less than, greater than, or equal to the third hydrophobicity. The greater hydrophobicity of the second region 36 and the third region 38 may reduce the permeation of liquid water through the respective regions 36, 38, thus form ing a barrier between any liquid water in the surroundings and the components of the first composite region 28. This reduces degradation of the sorbent material 24, 24′ within the first composite region 28 that liquid water could cause, increasing the lifetime and durability of the sorbent polymer composite article 20. The greater hydrophobicity of the second region 36 and the greater hydrophobicity of the third region 38 relative to the first hydrophobicity of the first composite region 28 may result from the lack of sorbent material 24, 24′ within the second and third regions 36, 38.

In some embodiments, the first composite region 28 is sealed with a coating (not shown). In certain instances, the coating is configured to be a carbon adsorbing material similar to the above-described sorbent materials 24, 24′.

The second porous polymer 40 of the second region 36 and the third porous polymer 48 of the third region 38 may be at least one of polytetrafluoroethylene (PTFE), expanded polytetrafluoroethylene (ePTFE), expanded polyethylene (ePE), or other suitable porous polymers. The second porous polymer 40 of the second region 36 may be identical to or different from the third porous polymer 48 of the third region 38. Further, the first porous polymer 22 of the first composite region 28, the second porous polymer 40 of the second region 36, and the third porous polymer 48 of the third region 38 may be identical to or different from each other.

In various embodiments, the thickness of the second region 36 is less than that of the first composite region 28, and the thickness of the third region 38 is less than that of the first composite region 28. The overall thickness of the sorbent polymer composite article 20 may be about 0.1 mm to about 5.0 mm. In certain embodiments, the thickness of the first composite region 28 may account for a majority of the overall thickness, such as about 70%, about 80%, about 90%, or more of the overall thickness.

The pore characteristics of the porous polymers 22, 40, 48 of each of the respective first composite region 28, the second region 36, and the third region 38 are variable. In certain embodiments, the second and third regions 36, 38 may have fewer and/or smaller pores 44, 54, than the first composite region 28 to selectively limit permeation of undesired contaminants (e.g., water) into the first composite region 28 while permitting permeation of desired molecules (e.g., CO₂) into the first composite region 28. By contrast, the first composite region 28 may have more and/or larger pores 32 than the second and third regions 36, 38 to encourage movement of CO₂ through the first composite region 28 for adsorption and desorption.

Further, the pore characteristics can be varied among different embodiments. This variation of the pore characteristics can be dependent on the entire thickness of the sorbent polymer composite article 20, as well as of the individual thicknesses of the first composite region 28, second region 36 and third region 38.

FIG. 2A is a schematic elevational view of the first composite region 28 of the sorbent composite article 20 of FIG. 2. In this embodiment, the sorbent polymer composite article 20 (FIG. 2) is relatively thick, for example approximately 3 mm, and the first composite region 28 has a thickness T1 that accounts for a majority of the overall thickness of the sorbent polymer composite 20. The sorbent polymer composite article 20 may be loaded with a desired amount of sorbent material 24 (e.g., about 60% sorbent material 24) to retain a relatively large void fraction, wherein the void fraction is a relative ratio of a volume of void space of the first composite region 28 to an entire volume of the first composite region 28. In this way, the sorbent polymer composite article 20 is relatively open in structure and there is relatively high accessibility of the sorbent material 24. While the distance required for diffusion of the gases may be farther in this embodiment due to the thickness T1, the sorbent material 24 remains accessible to the gases. As a result, the initial kinetics of the gas adsorbing to the sorbent material 24 may be slow, but the equilibrium of CO₂ adsorbing to the sorbent material 24 can be reached quickly in comparison to embodiments that are thinner, as will be described herein.

FIG. 2B is an alternate embodiment of the first composite region 28 of FIG. 2A wherein the sorbent composite article 20 (FIG. 2) has a median thickness, for example approximately 0.5 mm. In this embodiment, the first composite region 28 has a thickness T2 that accounts for the majority of the overall thickness of the sorbent polymer composite article 20. In this case, if the amount of polymer 22 (FIG. 2) of the first composite region 28 and the amount of sorbent material 24 is constant relative to the previous embodiment, the void fraction will be relatively smaller than the void fraction of the first composite region 28 of FIG. 2A. Thus, the sorbent polymer composite article 20 maintains a porosity wherein the gas is accessible to the sorbent material 24 but comparatively less accessible than the sorbent material 24 of the FIG. 2A embodiment. As a result, the initial kinetics of the gas adsorbing to the sorbent material 24 may be faster due to the shorter diffusion distance, but the time for equilibrium of CO₂ adsorption will increase relative to that of the embodiment in FIG. 2A.

FIG. 2C is alternate embodiment of the first composite region 28 of FIGS. 2A and 2B, wherein the sorbent polymer composite article 20 (FIG. 2) is relatively thin, for example approximately 0.1 mm. In this embodiment, the first composite region 28 has a thickness T3 that accounts for the majority of the overall thickness of the sorbent polymer composite article 20. In this case, if the amount of polymer 22 (FIG. 2) of the first composite region 28 and the amount of sorbent material 24 is constant relative to the previous two embodiments, the polymer 22 and available sorbent material 24 will be condensed even further within the sorbent polymer composite article 20. The diffusion distance required for the gases to pass through the article 20 is shorter due to the compressed thickness of the sorbent polymer composite article 20, but the sorbent material 24 is also less accessible to the gases. As a result, the initial kinetics of adsorption of the gases to the sorbent material 24 will be faster than the previous embodiments, but it may take longer for the system to reach a CO₂ adsorption equilibrium.

Referring back to FIG. 2, the pore characteristics of the sorbent polymer composite 20 may be varied within each layer, but also across various embodiments as a result of changing different characteristics, including the thickness of the sorbent polymer composite article 20, the thickness of the first composite region 28, the amount of sorbent material 24, 24′, and the amount of polymer 22 used within the sorbent polymer composite article 20. In this way, the relationship between diffusion length and sorbent material 24, 24′ accessibility can be varied for maximizing the function of the sorbent polymer composite article 20.

Further, the ability to vary the hydrophobicity, thickness, pore characteristics, and other properties of the first composite region 28, the second region 36, and the third region 38 may increase durability and conformability of the sorbent polymer composite article 20. Further, the use of a relatively thin and flexible sorbent polymer composite article 20 may allow the sorbent polymer composite article 20 to conform to different configurations for adsorption and desorption of the CO₂.

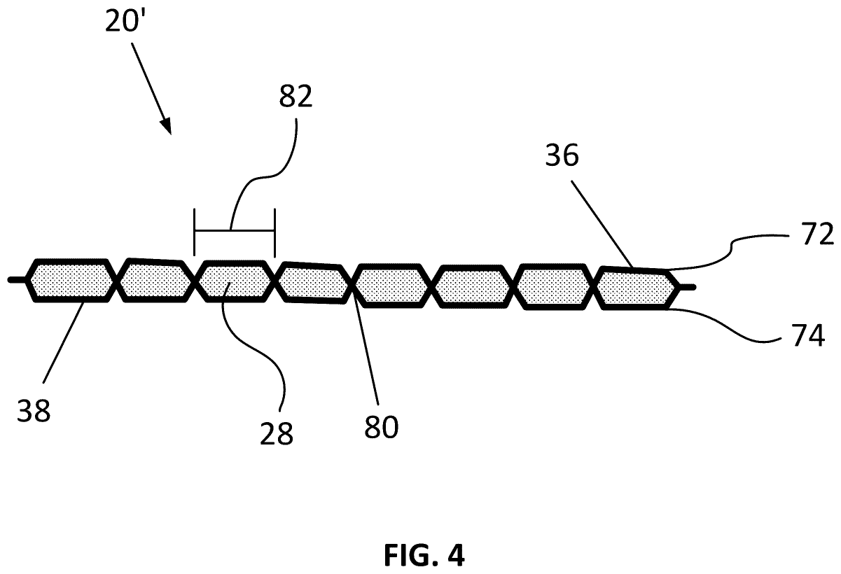

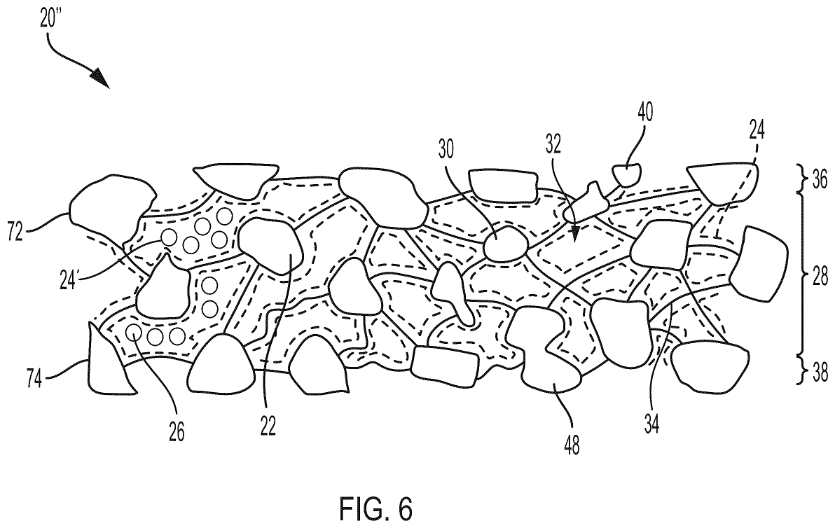

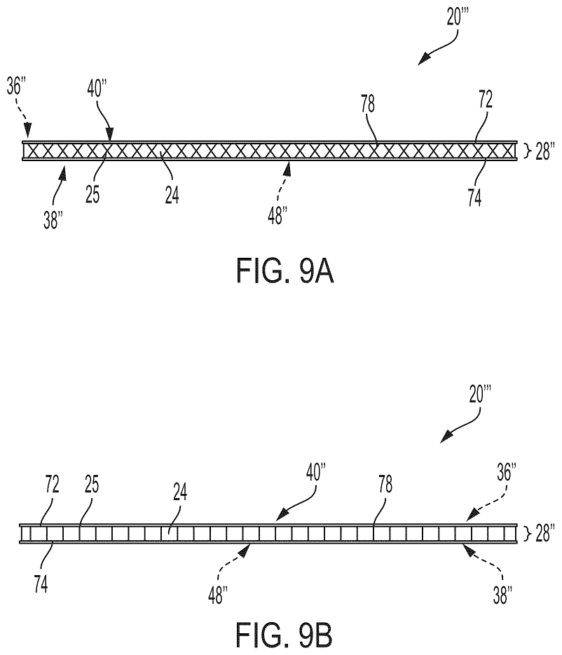

Referring still to FIG. 2, other useful components may be incorporated into the sorbent polymer composite articles 20, 20′ (referring to FIG. 4), and 20″ (referring to FIG. 6). The components may include fillers which could enhance the thermal conductivity. For instance, thermally conductive powders 78 could be blended into the mix, as shown in FIG. 2, or thermally conductive components (ex. aluminum filaments and/or weave) may be laminated into the constructs. In some instances, electrical conductors (e.g., wires, grids) may be incorporated. In some instances, adhesives which incorporate thermally conductive materials may be used to adhere regions of the sorbent polymer composite articles 20, 20′, 20″. One example of a useful component is a thermally and/or electrically conductive screen 25 (FIGS. 9A and 9B), which is described further below. Further, materials for the components may be chosen based on thermal conductivity, electrical conductivity, flexibility, ductility, hydrophobicity, thinness, durability, UV resistance, conformability, etc. for a certain application.

FIG. 2D is an additional elevational view of the sorbent polymer composite article of FIG. 2 with an additional end-sealing region 21. In embodiments, the sorbent polymer composite article 20 includes this end-sealing region 21 to protect the components of the sorbent polymer composite article 20. For example, if the sorbent polymer composite article 20 is cut or split in any manner, such as for production or manufacturing purposes, it may leave the first composite region 28, and thus the sorbent material 24, 24′ within the first composite region 28, exposed to external environment elements such as water, steam, or debris, which may be harmful to properties of the sorbent polymer composite article 20. Thus, embodiments with an end-sealing region 21 may be desirable. As illustrated in FIG. 2D, the end-sealing region 21 is positioned such that it may connect the polymer 40 of the second region 36 and the polymer 48 of the third region 38 and covers the exposed polymer 28 of the first composite region 28 on at least one side.

In the illustrated embodiment of FIG. 2D, the end-sealing region 21 is formed by applying an additional layer of a sealing material 47 onto the sorbent polymer composite article 20. The sealing material 47 may be the same as or different from the materials of the second region 36 and the third region 38. For example, the sealing material 47 may be ePTFE (as shown in FIG. 2A), ePE, silicone elastomer, or any other suitable non-porous and/or hydrophobic material that protects the first composite region 28. In other embodiments, the end-sealing region 21 may be formed by extending the second region 36 and the third region 38 and coupling (e.g., pinching, adhering) the regions 36, 38 together. The addition of this edge sealing step will benefit the composite by protecting the sorbent(s) retained in the composite and also by toughening the leading edge of the composite (which is the area most likely to incur damage from airborne debris and high-velocity strikes).

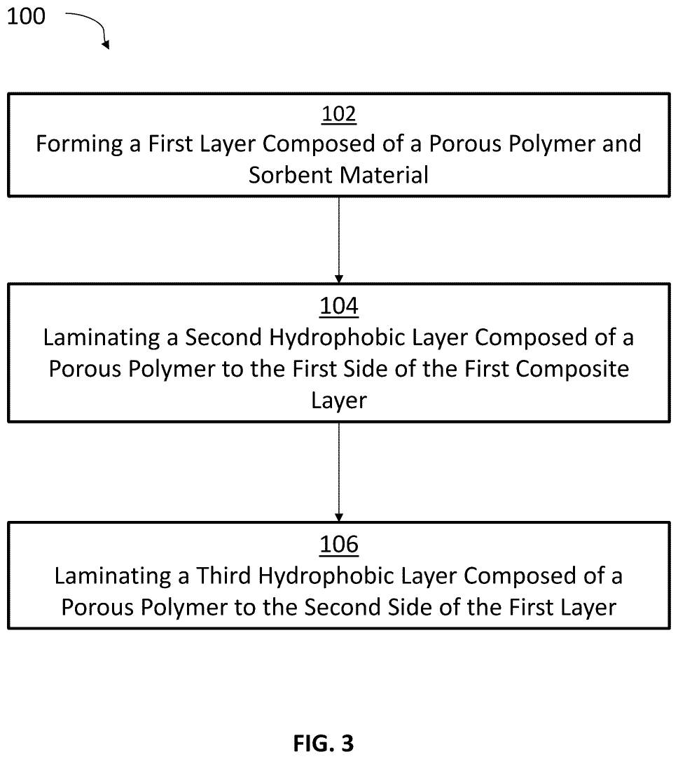

FIG. 3 is a flow chart illustrating a method 100 for form ing the above-described sorbent polymer composite article 20 (FIG. 2). At block 102, the method 100 includes forming the first composite region 28 that includes the first porous polymer 22 and the sorbent material 24, 24′ (FIG. 2). This forming step of block 102 may involve coating, entraining, and/or filling the first porous polymer 22 with the with the sorbent material 24, 24′, as discussed above.

At block 104, the method includes coupling the second hydrophobic region 36 onto the first side 72 of the first composite region 28, wherein the coupling includes laminating, adhering, or otherwise attaching the second hydrophobic region 36 to the first side 72 of the first composite region 28. At block 106, the method includes coupling the third hydrophobic region 38 onto the second side 74 of the first composite region 28, wherein the coupling includes laminating, adhering, or otherwise attaching the third hydrophobic region 38 to the second side 74 of the first composite region 28. In some embodiments, the coupling of the third hydrophobic region 38 in block 106 may occur before or simultaneously with the coupling of the second hydrophobic region 36 in block 104.

FIG. 4 illustrates a second exemplary embodiment of a sorbent polymer composite article 20′ of the present disclosure. The sorbent polymer composite article 20′ is similar to the above-described sorbent polymer composite article 20 (FIG. 2), with like reference numerals identifying like elements, except as described below. The sorbent polymer composite article 20′ includes the first composite region 28, the second region 36, where the second region 36 is coupled onto the first side 72 of the first composite region 28, and the third region 38, where the third region 38 is coupled onto the second side 74 of the first composite region 28. In this embodiment, sorbent polymer composite article 20′ includes a plurality of points of attachment 80 (i.e., connection points), where the second region 36 and the third region 38 connect to one another. A distance 82 between the points of attachments is variable and may be decreased or increased. In certain embodiments, an adhesive is used to create the points of attachment 80. In this way, the first composite region 28 may be sandwiched between the second region 36 on the first side 72 and the third region 38 on the second side 74 in the pocket-like areas between adjacent points of attachment 80. The points of attachment may be designed or engineered to create a uniform space between the regions 36 and 38 for the sorbent and carrier to reside and minimize the amount of surface area loss, yet position and support the sorbent and carrier(s) for optimum adsorption.

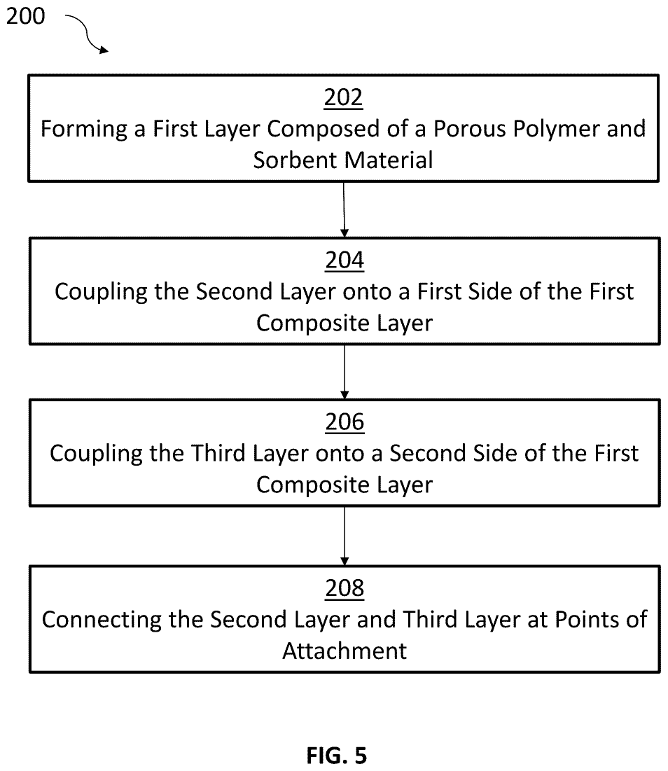

FIG. 5 is a flow chart illustrating a method 200 for form ing the above-described sorbent polymer composite article 20′ (FIG. 4). At block 202, the method 200 includes forming the first composite region 28 that includes a porous polymer and a sorbent material. At block 204, the method 200 includes coupling the second hydrophobic region 36 onto the first side 72 of the first composite region 28. At block 206, the method includes coupling the third hydrophobic region 38 onto the second side 74 of the first composite region 28. At block 208, the method 200 includes connecting the second hydrophobic region 36 and the third hydrophobic region 38 at points of attachment 80. In some embodiments, an adhesive is used to create the points of attachment 80. Using various points of attachment 80 allows for maximizing the surface area that is capable of adsorption and therefore minimizing the amount of adhesive needed and the surface area that the adhesive occupies. Variations of stitching patterns and sewing are also envisioned to attach the layers 36 and 38 together at specific points.

FIG. 6 illustrates a third exemplary embodiment of sorbent polymer composite article 20″ of the present disclosure. The sorbent polymer composite article 20″ is similar to the above-described sorbent polymer composite article 20 (FIG. 2) and sorbent polymer composite article 20′ (FIG. 4), with like reference numerals identifying like elements, except as described below. The sorbent polymer composite article 20″ includes a first composite region 28 having a first porous polymer 22 and a sorbent material 24, 24′, as described above.

The sorbent polymer composite article 20″ further comprises a second region 36 that has been integrally formed with the first side 72 of the first composite region 28. In this embodiment, the first porous polymer 22 of the first composite region 28 may be continuous with the second porous polymer 40 of the second region 36. In certain embodiments, the sorbent polymer composite article 20″ may further include a third region 38 having a third porous polymer 48 that is integrally formed with the second side 74 of the first composite region 28. In this embodiment, the first porous polymer 22 of the first composite region 28 may be continuous with the third porous polymer 48 of the third region 38.

In certain embodiments, the second region 36 and the third region 38 are regions of modified surfaces of the first composite region 28 of the sorbent polymer composite article 20″, the sorbent polymer composite article 20″ being monolithic. In these embodiments, the second region 36 and the third region 38 may be created by performing a surface treatment on the porous polymers 40, 48 that results in each region 36, 38 having a higher hydrophobicity than the hydrophobicity of the first porous polymer 22 of the first composite region 28. This surface treatment may include eroding the sorbent material 24, 24′ beyond the first side 72 of the first composite region 28 and beyond the second side 74 of the first composite region 28 such that the porous polymers 40, 48 of the second region 36 and the third region 38, respectively, does not contain the sorbent material 24, 24′. Rather than applying and then eroding the sorbent material 24, 24′ from the second region 36 and the third region 38, the surface treatment may involve masking the second region 36 and the third region 38 such that the sorbent material 24, 24′ is deposited only within the first composite region 28. The surface treatment may also involve applying a hydrophobic coating to the second region 36 and the third region 38. More information regarding these and other surface treatments is provided below.

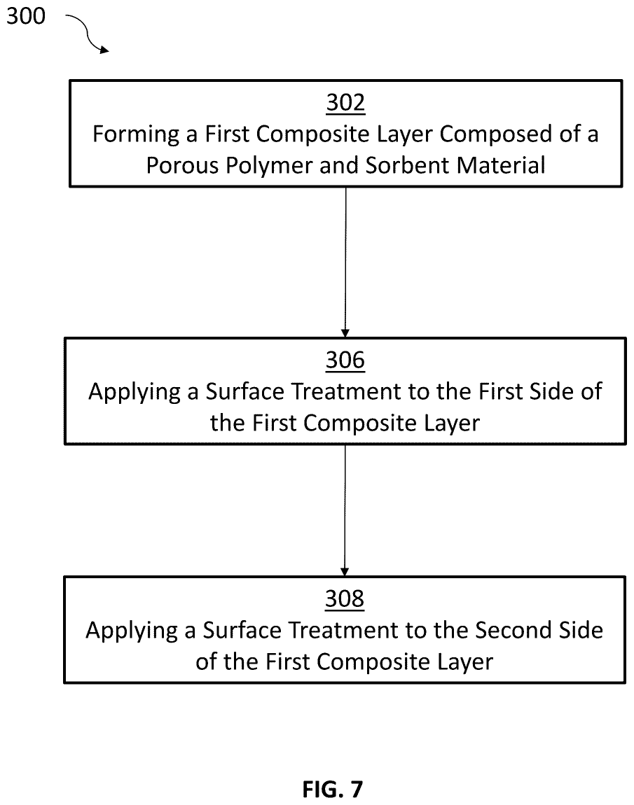

FIG. 7 is a flow chart illustrating a method 300 for form ing the above-described sorbent polymer composite article 20″ (FIG. 6). At block 302, the method 300 includes forming a first composite region 28 composed of a first porous polymer 22 and a sorbent material 24, 24′. At block 306, the method 300 includes applying a surface treatment to the first side 72 of the first composite region 28. This surface treatment may include eroding the sorbent material 24, 24′ beyond the first side 72. The erosion may be completed through the use of heat, a solvent or plasma. In other instances, the surface treatment may include applying a wash, applying a plasma treatment, or masking the area beyond the first side 72 with a hydrophobic substance. At block 308, the method 300 includes applying a surface treatment to the second side 74 of the first composite region 28. This surface treatment may include eroding the sorbent material 24, 24′ beyond the second side 74. The erosion may be completed through the use of heat, a solvent or plasma. In other instances, the surface treatment may include applying a wash, applying a plasma treatment, or masking the area beyond the second side 74 with a hydrophobic substance.

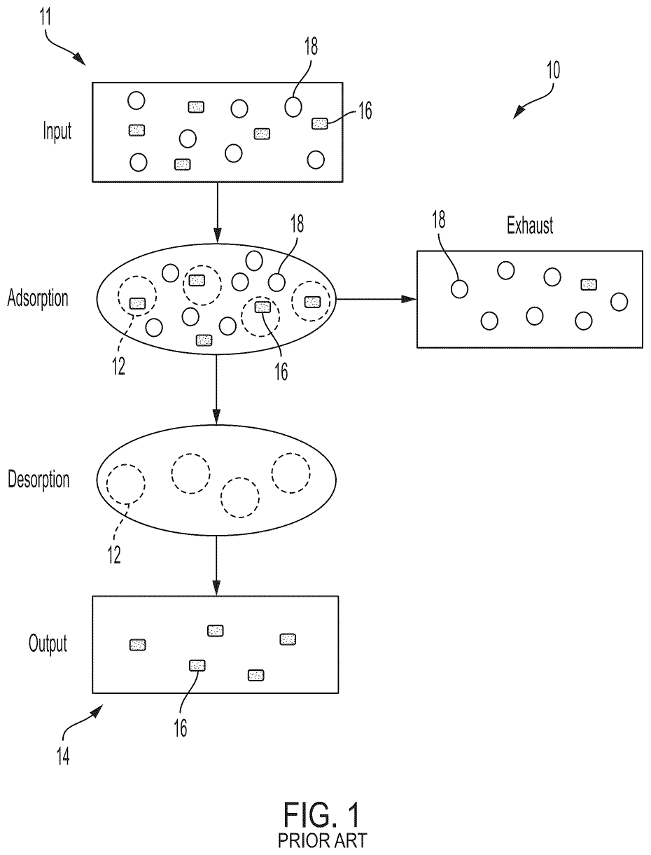

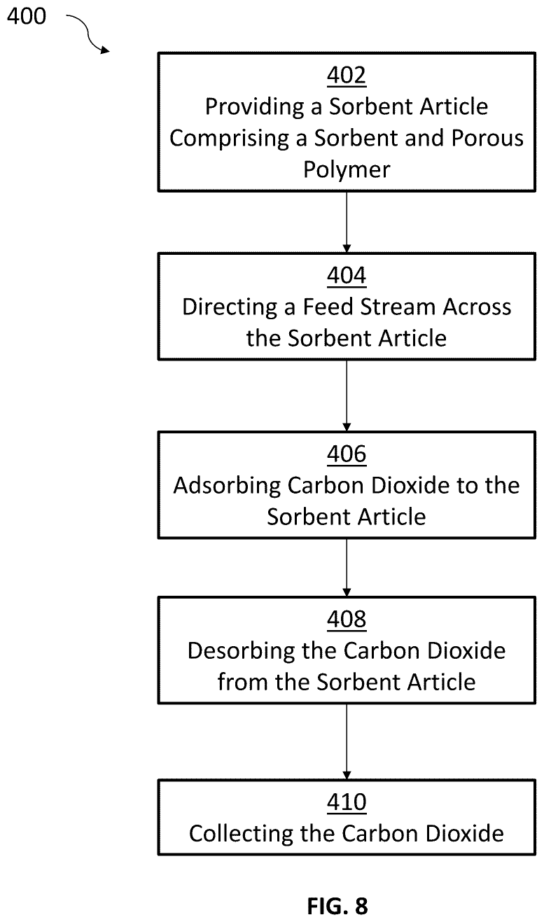

FIG. 8 is a flow chart illustrating a basic method 400 of using the above described sorbent polymer composite article 20 of FIG. 2 for adsorption, specifically DAC. In embodiments, the method of using 400 is varied to use the sorbent polymer composite article 20 of FIG. 2 in adsorption processes other than DAC, as noted above. While the method 400 is explained with reference to the sorbent polymer composite article 20 of FIG. 2, the method 400 applies equally to sorbent 20′ and sorbent polymer composite article 20″ of FIG. 4 and FIG. 6, respectively. At block 402, the method 400 includes providing the sorbent polymer composite article 20. At block 404, the method 400 includes directing a feed stream, which may be similar to the air input stream 11 of FIG. 1 comprising CO₂ molecules 16, across the sorbent polymer composite article 20. Other suitable input streams 11 include liquids (e.g., ocean water) or other vapors. At block 406, the method 400 includes adsorbing the CO₂ molecules 16 onto the sorbent polymer composite article 20. At block 408, the method 400 includes desorbing the CO₂ molecules 16 (FIG. 1) from the sorbent polymer composite article 20, thereby regenerating the sorbent polymer composite article 20 for further use. In certain instances, this desorbing step of block 408 comprises applying at least one of water, water vapor or heat to the sorbent polymer composite article 20. At block 410, the method 400 includes collecting the CO₂ molecules 16 with a vacuum or another suitable collection technique for a desired end use.

In certain embodiments, the steps of adsorbing the CO₂ molecules 16 to the sorbent polymer composite article 20 at block 406 and subsequently desorbing the CO₂ 16 from the sorbent polymer composite article 20 at block 408 may be repeated. Thus, the sorbent polymer composite article 20 may cycle between adsorbing and desorbing stages efficiently and with increased durability.

FIG. 9A is an illustrative embodiment of a fourth sorbent polymer composite article 20′″. The sorbent polymer composite article 20′″ includes a first region 28″ that comprises a sorbent material 24 and a screen 25 (e.g., fiberglass, wire). The screen 25 may have a lattice-type arrangement and may extend along the entirety of the first side 72 and second side 74 of the first composite region 28″. The screen 25 may provide structural support for the sorbent polymer composite article 20 and the retained sorbent material 24, similar to the first porous polymer 22 described in previous embodiments. Also, as noted above, the screen 25 may be considered a useful component, as described above, that promotes thermal and/or electrical conductivity within the sorbent polymer composite article 20′″. The sorbent polymer composite article 20′″ further includes a second region 36″ of a second porous polymer 40″ and/or a third region 38″ of a third porous polymer 48″, as described above, which may immobilize the sorbent material 24 in the screen 25.

FIG. 9B is an illustrative embodiment of a variation of the sorbent polymer composite article 20′″ illustrated in FIG. 9A. In this embodiment, the screen 25 may have a grid-type arrangement instead of the lattice-type arrangement of FIG. 9A. Other variations are also within the scope of the present disclosure.

### EXAMPLES

### Example 1

A sorbent polymer composite article was produced incorporating a sorbent filled tape. The sample was produced by obtaining an amorphous silica powder (Syloid C 803, available from Grace Industries, Columbia, MD.) and combining with a PTFE resin. The proportions of the blend were 60% by weight of silica and 40% by weight of PTFE. The components were blended using the process described in U.S. Pat. No. 4,985,296 to Mortimer, Jr. The process included mixing the blend of 60% by weight silica and 40% by weight of PTFE in an aqueous dispersion. Next, the process included coagulating the filler and the PTFE. The process then included lubricating the filled PTFE with an extrusion lubricant (Isopar K) and paste extruding to form a tape. The process then included expanding the tape by stretching it and forming the porous PTFE tape with the filler distributed within it, and lastly compressing it to the desired thickness. The resultant filled tape measured approximately 0.762 mm thick and 150 mm wide. This tape was cut into samples approximately 53 mm×85 mm.

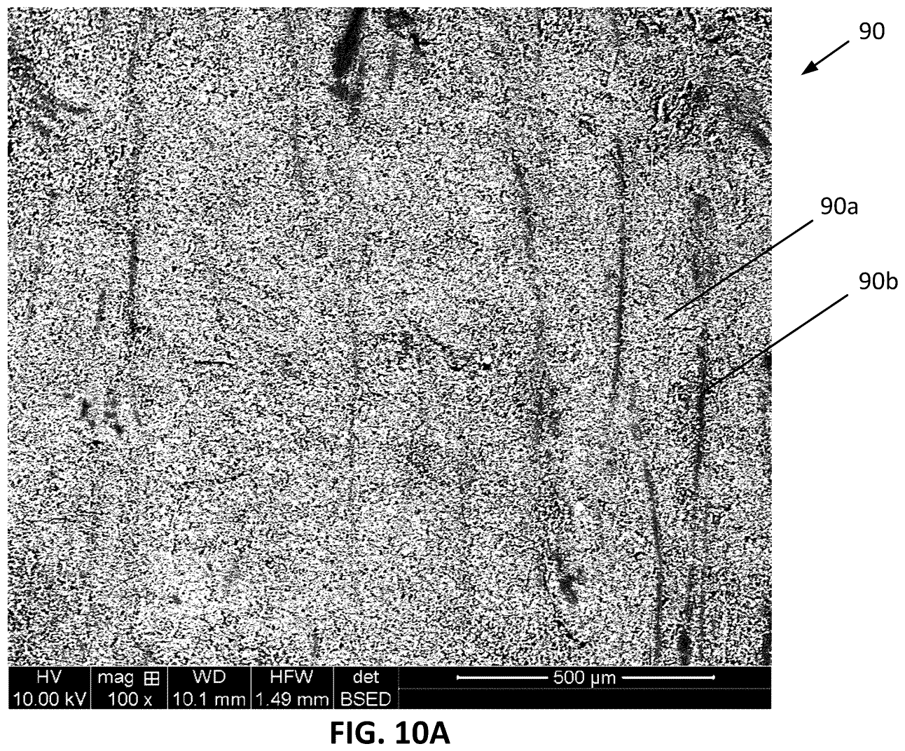

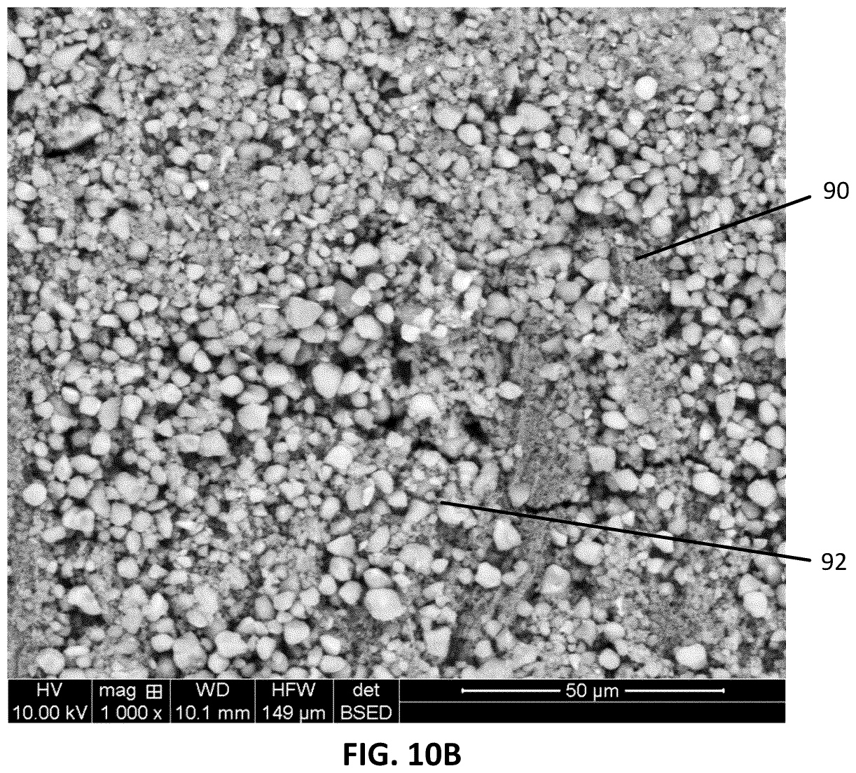

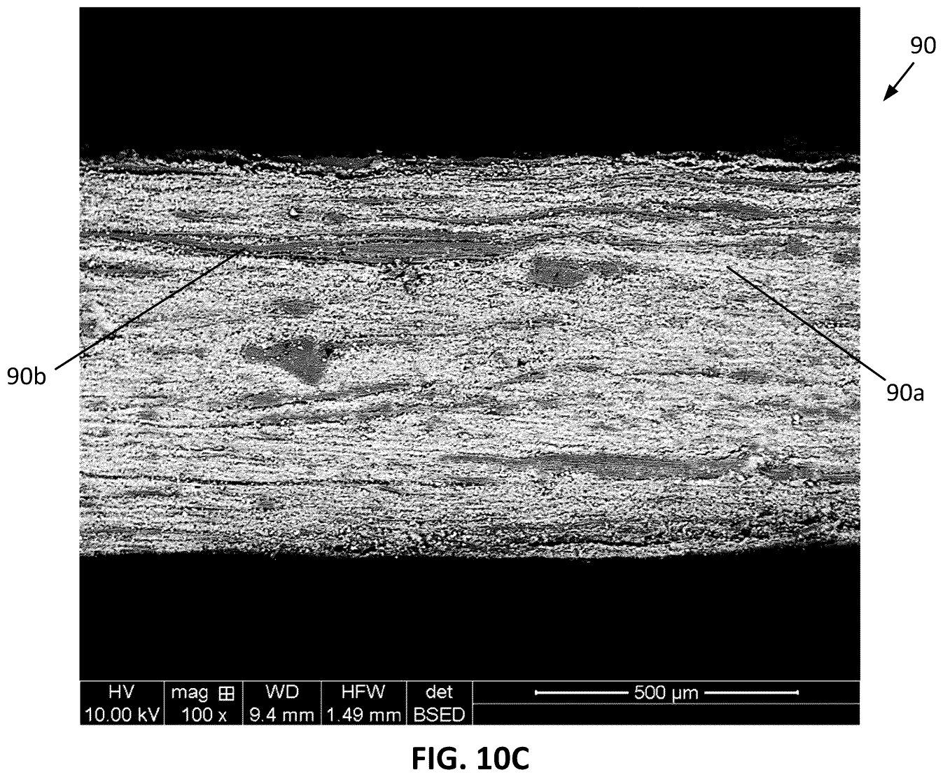

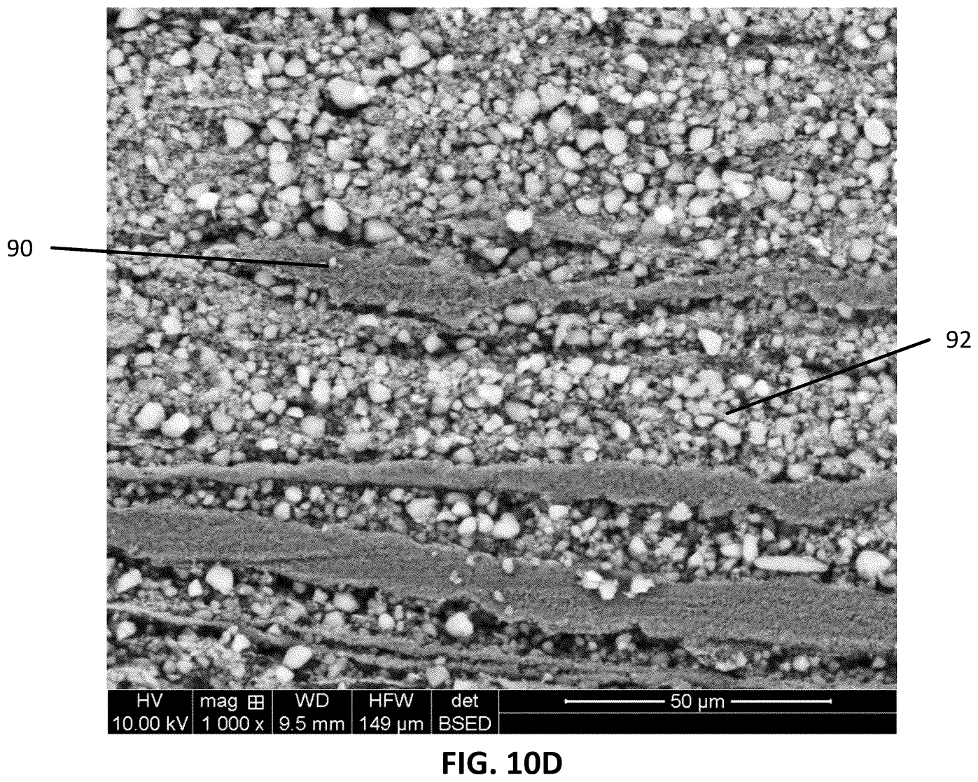

FIGS. 10A, 10B, 10C, and 10D are scaled SEM images that were taken of this sample. The SEM images are at the scales noted in the respective images. FIG. 10A displays a surface image of the tape 90 at a 100× magnification showing some variation in the surface with light areas 90a and bands of dark areas 90b with a scale showing the length of 500 μm relative to the image. Indicated at the bottom of the image are: HV 10.00 kV, mag 100×, WD 10.1 mm, HFW 1.49 mm, det BSED. FIG. 10B illustrates a higher magnification SEM of the same surface of the tape 90 at a 1000× magnification with a scale showing the length of 50 μm relative to the image, wherein the silica particles 92 are illustrated and embedded within the polymer, with the light areas 90a of FIG. 10A being the silica particles 92 and the dark areas of FIG. 10A being the polymer supporting the silica particles 92. Indicated at the bottom of the image are: HV 10.00 kV, mag 1000×, WD 10.1 mm, HFW 149 μm, det BSED. FIG. 10C displays a cross-sectional image of the same tape 90 of FIG. 10A at a 100× magnification showing some variation in the surface with light areas 90a and bands of dark areas 90b with a scale showing the length of 500 μm relative to the image. Indicated at the bottom of the image are: HV 10.00 kV, mag 100×, WD 9.4 mm, HFW 1.49 mm, det BSED. FIG. 10D illustrates a higher magnification SEM of the same cross section of the sorbent polymer composite article at a 1000× magnification with a scale showing the length of 50 μm relative to the image, wherein the silica particles 92 are again apparent and embedded in the polymer, with the light areas 90a of FIG. 10C being the silica particles 92 and the dark areas of FIG. 10C being the polymer supporting the silica particles 92. Indicated at the bottom of the image are: HV 10.00 kV, mag 1000×, WD 9.5 mm, HFW 149 μm, det BSED.

### Example 2

A sorbent polymer composite article was produced incorporating a fiberglass screen between membranes of ePTFE. This sample was produced by first spraying two coats of polyurethane adhesive (Gorilla brand Spray Adhesive, Gorilla Glue Company, Cincinnati, OH), onto a fiberglass mesh/screen (Saint-Gobain, ADFORS, Fiberglass Vent Screen). The adhesive was allowed to dry until it was no longer tacky. An expanded ePTFE was obtained that was produced in accordance with the teachings of U.S. Pat. No. 5,814,405 to Branca et al. The ePTFE membrane was adhered to one side of the adhesive-coated screen using local heat from a soldering iron to reflow the polyurethane and cause adhesion. The same silica powder as mentioned in Example 1 was then applied to the construct and the screen apertures were filled with the silica. A straight-edge (ruler) was used to level the powder along the screen surface. Another layer of the same ePTFE membrane was used to cover the screen and powder. This construct was set into a t-shirt press set to 150 degrees C. The press was closed and applied pressure and heat to the construct for 30 seconds. The sample was removed, cooled and trimmed with scissors. The final samples measure approximately 53 mm×85 mm.

### Example 3

A sorbent polymer composite article was produced incorporating a sorbent filled tape. The sample was produced by obtaining an amorphous silica powder (Syloid C 803, available from Grace Industries, Columbia, MD.) and combining with a PTFE resin. The proportions of the blend were 60% by weight of silica and 40% by weight of PTFE. The mixture was then processed into a tape as described in Example 1. The resultant tape measured approximately 0.762 mm thick and 150 mm wide.

An expanded ePTFE membrane was obtained which was produced in accordance with the teachings of U.S. Pat. No. 5,814,405 to Branca et al. The ePTFE membrane was placed on both surfaces of the sample. The sample was then placed in a Carver hydraulic press and compressed between shims of aluminum. The pressure compressed the sample to approximately ⅓ its original thickness. The samples were removed and trimmed to approximately 53 mm×85 mm.

The sorbent polymer composite articles of Example 1, 2, and 3 were then analyzed for several characteristics. One tested characteristic was the hydrophobicity of the sorbent polymer composite article. The hydrophobicity tests revealed that the hydrophobicity of the sorbent polymer composite was not altered by the coating. While PEI is hydrophilic, the studies found that the hydrophobicity of the ePTFE layers was maintained in the sorbent polymer composite article after coating treatment. Results also showed that the critical size of the H2O droplets determined if they would run off of the sorbent polymer composite article or remain on the surface. However, shaking the sorbent polymer composite articles removed the H₂O droplets that remained on the sorbent polymer composite article. This is a benefit of creating a conformable sorbent polymer composite article.

Further, the sorbent polymer composite articles of Example 1, 2, and 3 were subjected high temperatures to replicate temperature swing adsorption. The samples were able to endure 5 cycles of the temperature swing adsorption while maintaining proper function.

### Example 4

A sorbent polymer composite article was produced incorporating a filled tape containing Dowex particles. Dowex Marathon A in chloride form was obtained from Lenntech USA, South Miami, FL. The resin was then cryo-milled to an approximately 50 micron mean size. The Dowex resin powder was then mixed with PTFE resin at a ratio of 60% by weight Dowex and 40% by weight PTFE. The mixture was then processed into a tape as described in Example 1. The resultant tape measured approximately 0.762 mm thick and 150 mm wide. This tape was cut into samples approximately 53 mm×85 mm and labeled for testing.

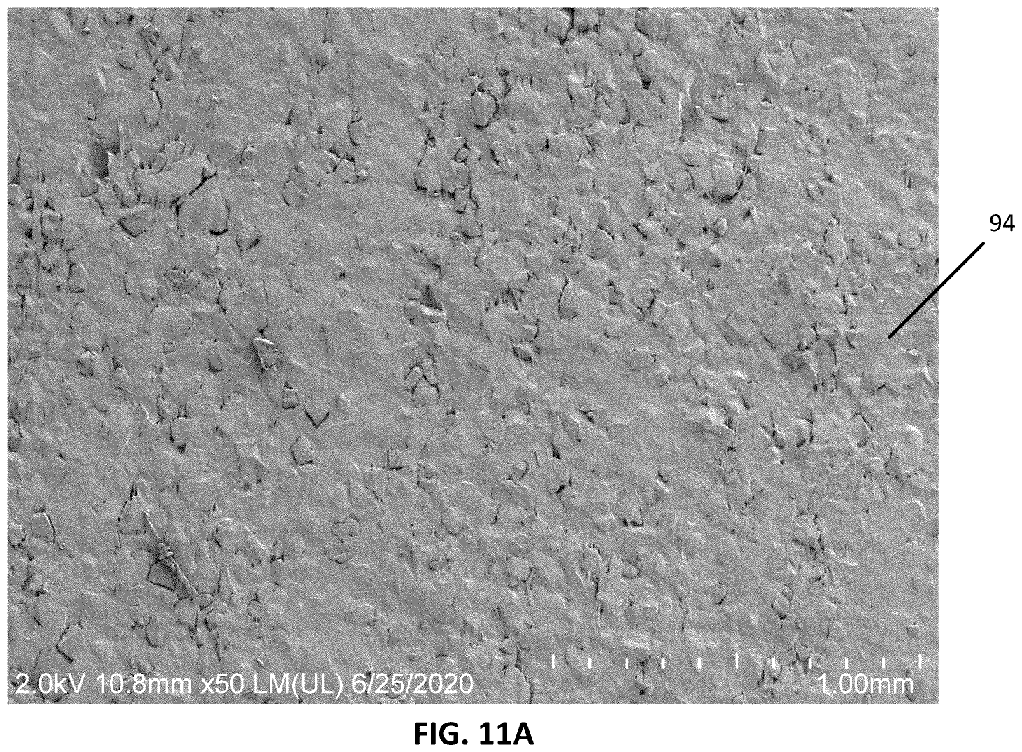

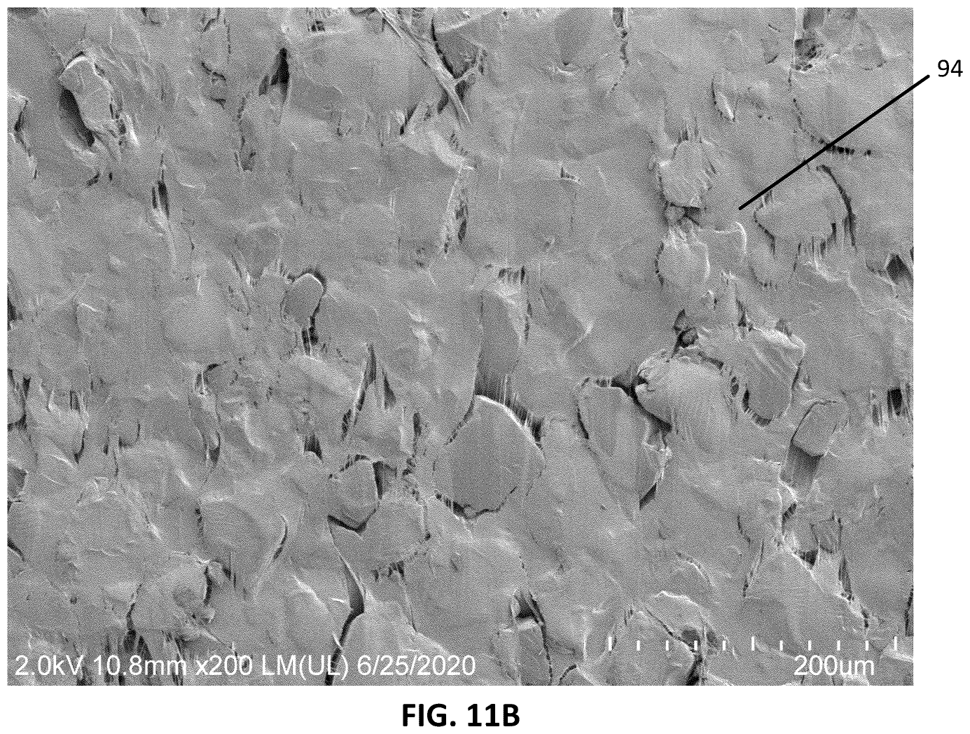

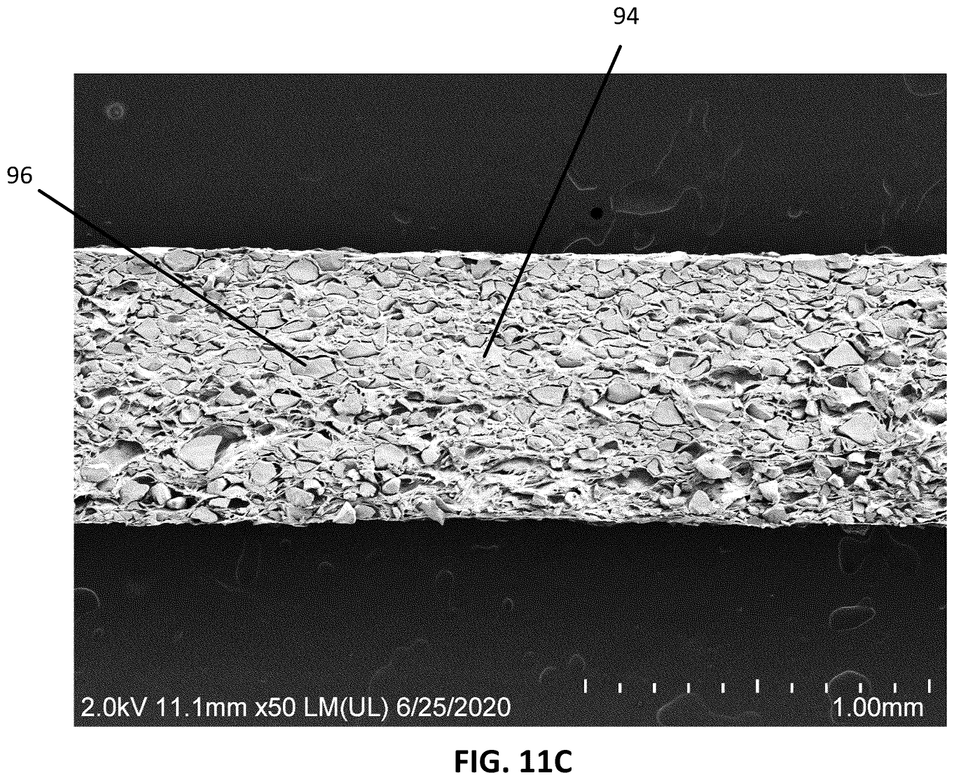

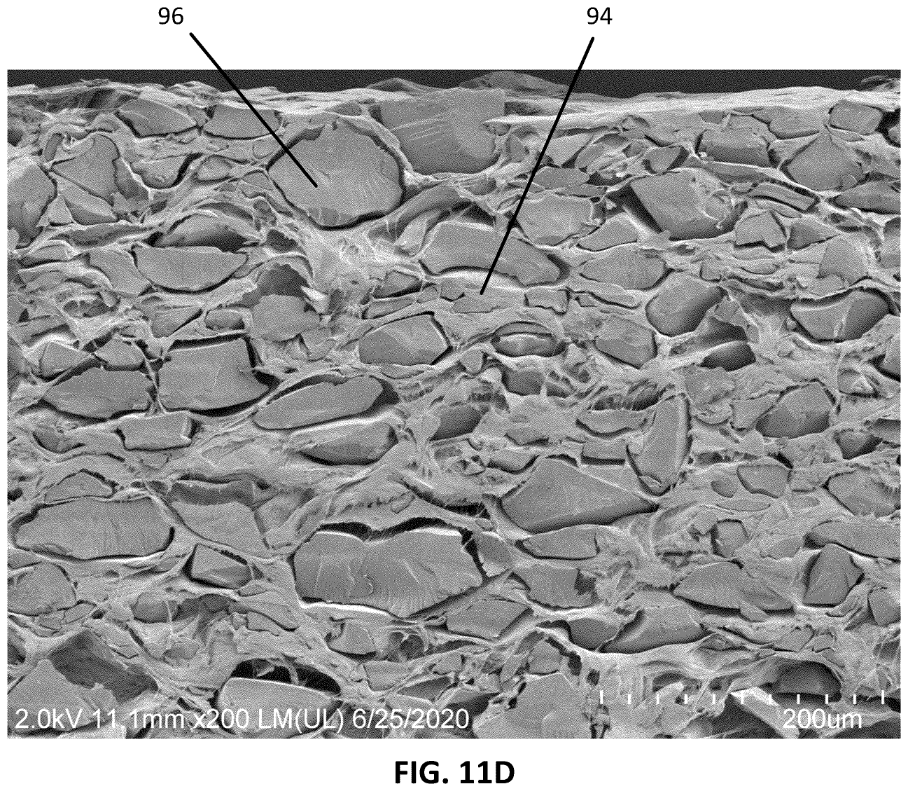

FIGS. 11A, 11B, 11C, and 11D are SEM images that were taken of this sample. The SEM images are at the scales noted in the respective images. FIG. 11A displays a surface image of the Dowex tape at a 50× magnification with a scale showing the length of 1.00 mm relative to the image (such that a distance between two consecutive vertical markers represents 0.1 mm), showing the polymer 94 supporting filler particles 96 and the presence of a PTFE skin 95 across the surface of many particles 96. Indicated at the bottom of the image are: 2.0 kV 10.8 mm×50 LM (UL) 6/25/2020. FIG. 11B illustrates a higher magnification SEM of the same surface of the Dowex tape at a 200× magnification with a scale showing the length of 200 μm relative to the image (such that a distance between two consecutive vertical markers represents 20 μm), showing again the polymer 94 supporting filler particles 96 and the presence of a PTFE skin 95 across the surface of many particles 96. Indicated at the bottom of the image are: 2.0 kV 10.8 mm×200 LM (UL) 6/25/2020. FIG. 11C displays a cross-sectional image of the same Dowex tape of FIG. 11A at a 50× magnification with a scale showing the length of 1.00 mm relative to the image (such that a distance between two consecutive vertical markers represents 0.1 mm), showing the polymer 94 forming layers that support filler particles 96. Indicated at the bottom of the image are: 2.0 kV 11.1 mm×50 LM (UL) 6/25/2020. FIG. 11D illustrates a higher magnification SEM of the same cross section of the Dowex tape at a 200× magnification with a scale showing the length of 200 μm relative to the image (such that a distance between two consecutive vertical markers represents 20 μm), that again shows the polymer 94 forming layers that support filler particles 96. Indicated at the bottom of the image are: 2.0 kV 11.1 mm×200 LM (UL) 6/25/2020. In both FIG. 11A and FIG. 11B, the Dowex particles are not clearly visible as they are embedded under the surface of the polymer 94. In FIGS. 11C and 11D, the cross section shows the Dowex particles 96 embedded within the polymer 94.

### Example 5a

Process 1 (Dry)

A sorbent polymer composite article was produced incorporating a fiberglass screen between membranes of ePTFE. This sample was produced by first spraying two coats of polyurethane adhesive (Gorilla brand Spray Adhesive, Gorilla Glue Company, Cincinnati, OH), onto a fiberglass mesh/screen (Saint-Gobain, ADFORS, Fiberglass Vent Screen). The adhesive was allowed to dry until it was no longer tacky. An expanded ePTFE was obtained that was produced in accordance with the teachings of U.S. Pat. No. 5,814,405 to Branca et al. The ePTFE membrane was adhered to one side of the adhesive-coated screen using local heat from a soldering iron to reflow the polyurethane and cause adhesion. The same Dowex resin mentioned in Example 4 was then applied to the construct and the screen apertures were filled with the resin. A straight-edge (ruler) was used to level the powder along the screen surface. Another layer of the same ePTFE membrane was used to cover the screen and resin. This construct was set into a t-shirt press set to 125 degrees C. The press was closed and applied pressure and heat to the construct for 30 seconds. The sample was removed, cooled and trimmed with scissors to approximately 53 mm×85 mm.

### Example 5b

Process 2 (Wet)

A sorbent polymer composite article was produced incorporating a fiberglass screen between membranes of ePTFE. This sample was produced by first spraying two coats of polyurethane adhesive (Gorilla brand Spray Adhesive, Gorilla Glue Company, Cincinnati, OH), onto a fiberglass mesh/screen (Saint-Gobain, ADFORS, Fiberglass Vent Screen). The adhesive was allowed to dry until it was no longer tacky. An expanded ePTFE membrane was obtained which was produced in accordance with the teachings of U.S. Pat. No. 5,814,405 to Branca et al. The ePTFE membrane was adhered to one side of the adhesive-coated screen using local heat from a soldering iron to reflow the polyurethane and cause adhesion. The same Dowex resin as mentioned in Example 5a was then mixed with 70% IPA until it obtained a consistency of a thin slurry. It was then applied to the construct and the screen apertures were filled with the resin slurry. A straight-edge (ruler) was used to level the slurry along the screen surface. Another layer of the same ePTFE membrane was used to cover the screen and resin. This construct was allowed to dry for 30 minutes and then placed into a t-shirt press set to 125 degrees C. The press was closed and applied pressure and heat to the construct for 30 seconds. The sample was removed, cooled and trimmed with scissors to approximately 53 mm×85 mm.

Those of skill in the art will recognize that other porous materials may be readily substituted in the foregoing example. It will be appreciated that non-woven materials such as nanospun, meltblown, spunbond and porous cast films could be substituted for the fiberglass mesh/screen of Examples 5a and 5b.

### Example 6

A sorbent polymer composite article was produced incorporating a layer of SnowPure laminated with ePTFE sheets on either side. A polypropylene-base membrane containing a Dowex Marathon A resin, available from SnowPure, LLC, San Clemente, Calif. was obtained. An expanded ePTFE membrane was obtained which was produced in accordance with the teachings of U.S. Pat. No. 5,814,405 to Branca et al. The ePTFE membrane was placed on each surface of the SnowPure material and tacked in place using the localized heat of a soldering iron tip. The heat of the soldering iron partially melted the polypropylene substrate in the SnowPure membrane and caused adhesion to the ePTFE. The sample was then cut/trimmed to approximately 53 mm×85 mm.

The samples from Examples 5a, 5b, and 6 were analyzed for their performance when undergoing moisture swing adsorption in comparison with the competing article (SnowPure only) as the baseline.

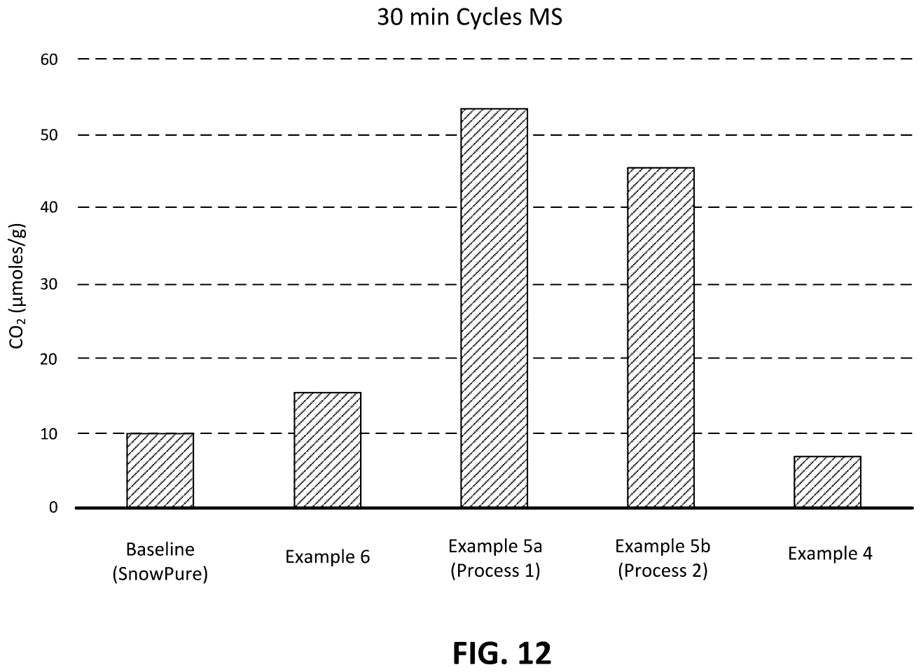

FIG. 12 displays the amount of CO₂ that was adsorbed onto the sorbent polymer composite articles (in pmoles/g) when using 30-minute cycles of moisture swing adsorption. The results show that the sorbent polymer composite article formed according to Example 5a (Process 1) achieved the highest CO₂ adsorption of the tested sorbent polymer composite articles, with the sorbent polymer composite article formed according to Example 4 achieving the lowest CO₂ adsorption. The baseline sorbent polymer composite article and the sorbent polymer composite article produced according to Example 6 performed better than that of Example 4, but not as well as that of Example 5a or Example 5b.

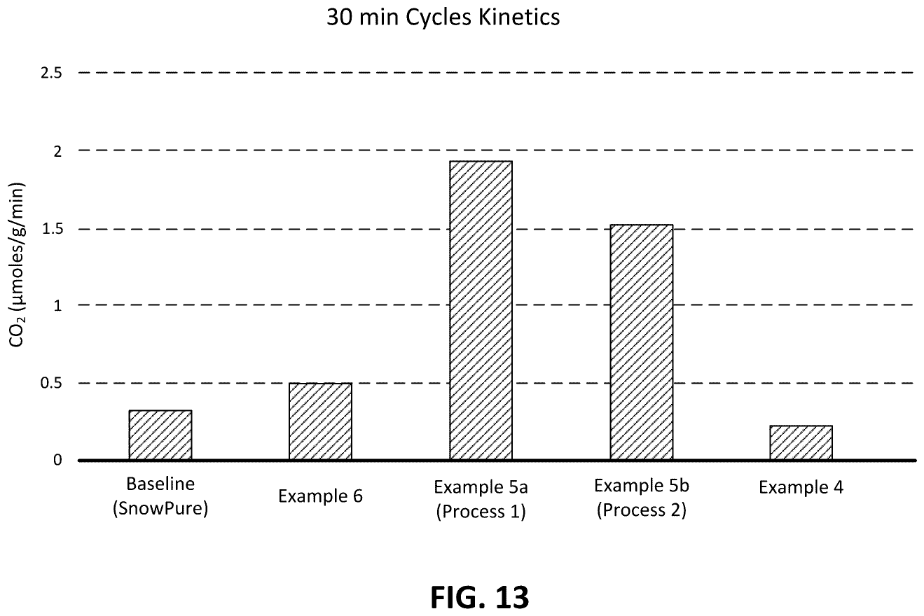

FIG. 13 is similar to FIG. 12 but displays the kinetic results in terms of the amount of CO₂ that was adsorbed onto the sorbent polymer composite articles over time (in pmoles/g/m in) during a 30-minute cycle of moisture swing adsorption. Like the results of FIG. 12, the best performing sample was that of Example 5a (Process 1), followed by the sample of Example 5b (Process 2). The least desirably performing sorbent polymer composite article was again that of Example 4. The baseline sample and the sample of Example 6 did not perform as well as the samples of Example 5a and Example 5b but did perform better than the sample of Example 4.

The results with respect to the CO₂ adsorption and the kinetics of the adsorption both suggest the benefits of using the Dowex and ePTFE sorbent polymer composite article composites formed according to Examples 5a and 5b.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

1. A sorbent polymer composite article comprising;
a first composite region comprising a first porous polymer and a sorbent material, the first composite region having a first hydrophobicity; and
a second region of a second porous polymer positioned adjacent to a first side of the first composite region, the second region having a second hydrophobicity that exceeds the first hydrophobicity.

2. The sorbent polymer composite article of claim 1, wherein the sorbent polymer composite article further includes a third region of a third porous polymer positioned adjacent to a second side of the first composite region, the third region having a third hydrophobicity that exceeds the first hydrophobicity.

3. (canceled)

4. The sorbent polymer composite article of claim 2, wherein the greater hydrophobicity of both the second and third regions relative to the first composite region is defined by the absence of the sorbent material within the second region and the third region.

5. The sorbent polymer composite article of claim 1, wherein the first porous polymer of the first composite region is continuous with the second porous polymer of the second region or the third porous polymer of the third region.

6.-9. (canceled)

10. The sorbent polymer composite article of the claim 2, wherein the thickness of the second region is less than the thickness of the first composite region and the thickness of the third region is less than the thickness of the first composite region.

11. (canceled)

12. The sorbent polymer composite article of claim 1, wherein the first composite region further comprises a carrier, and the sorbent is configured to coat the carrier of the first composite layer and does not coat the porous polymer of the first composite layer.

13.-17. (canceled)

18. The sorbent polymer composite article of claim 2, wherein the first composite region has larger pores than the second region and the third region.

19. The sorbent polymer composite article of claim 1, further comprising at least one useful component selected comprising an electroconductive material, a thermal conductor material, or a hydrophobic material.

20. A method of forming a sorbent polymer composite article comprising the steps of:
forming a first composite region comprising a first porous polymer and a sorbent material; and
forming a second hydrophobic region comprising a second porous polymer on a first side of the first composite region.

21. The method of claim 20, wherein the second hydrophobic region is a discrete layer from the first composite region, and wherein the step of forming the second hydrophobic region on the first side of the first composite layer includes coupling the second porous polymer of the second hydrophobic layer to the first side of the porous polymer of the first composite layer, and wherein the step of forming the second hydrophobic region on the first side of the first composite layer includes coupling the second porous polymer of the second hydrophobic layer to the first side of the porous polymer of the first composite layer.

22. (canceled)

23. The method of claim 20, wherein the method further comprises the step of forming a third hydrophobic region comprising a third porous polymer on a second side of the first composite layer, wherein the third hydrophobic region is a discrete layer from the first composite region, and wherein the step of forming the third hydrophobic region on the second side of the first composite region further includes coupling the third porous polymer of the third hydrophobic region to the second side of the first porous polymer of the first composite region.

24.-25. (canceled)

26. The method of claim 21, wherein the coupling step comprises laminating the second hydrophobic region onto the first side of the first composite region or the second side of the first composite region.

27. (canceled)

28. The method of claim 23, further comprising connecting the second hydrophobic region to the third hydrophobic region by creating points of attachment along the length of the sorbent polymer composite article such that the first composite region is sandwiched between the second hydrophobic region and the third hydrophobic region between adjacent points of attachment, wherein a distance between adjacent points of attachment along the sorbent polymer composite article is varied.

29.-30. (canceled)

31. The method of claim 20, wherein the step of forming the first composite region comprising the first porous polymer and the sorbent material further includes coating the first porous polymer with a sorbent coating, and the step of forming the second hydrophobic region on the first side of the first composite region further includes applying a surface treatment beyond the first side of the first composite region.

32. The method of claim 23, wherein the step of forming the first composite region comprising the first porous polymer and the sorbent material further includes coating the first porous polymer with a sorbent coating, and the step of forming the third hydrophobic region on the second side of the first composite region further includes applying a surface treatment beyond the second side of the first composite region.

33. (canceled)

34. A method of using a sorbent polymer composite article for adsorption comprising the steps of:
providing a sorbent polymer composite article comprising a first composite region comprising a first porous polymer and a sorbent and having a first hydrophobicity, and a second region positioned adjacent to a first side of the first region and having a second hydrophobicity that exceeds the first hydrophobicity;
directing a feed stream comprising carbon dioxide across the sorbent polymer composite article; and
adsorbing the carbon dioxide into the sorbent polymer composite article.

35. The method of claim 34, wherein the step of providing the sorbent polymer composite article further comprises forming a third region of a third porous polymer on a second side of the first region and having a third hydrophobicity that exceeds the first hydrophobicity.

36. The method of claim 34, further comprising desorbing the carbon dioxide by applying at least one of water and heat to the sorbent polymer composite article.

37. The method of claim 34, further comprising collecting the desorbed carbon dioxide using a vacuum.

38. A sorbent polymer composite article comprising:
a first region having a sorbent material and a screen;
a second region comprising a second polymer positioned adjacent the first region; and
a third region comprising a third polymer positioned adjacent the first region.

39. (canceled)

40. The sorbent polymer composite article of claim 38, wherein
the screen is electrically or thermally conductive or is comprised of fiberglass or wires.

41. (canceled)

42. A sorbent polymer composite article comprising:
a first composite region comprising a first porous polymer and a sorbent material, the first composite region having a first hydrophobicity;
a second region of a second porous polymer positioned adjacent to a first side of the first composite region, the second region having a second hydrophobicity that exceeds the first hydrophobicity;
a third region of a third porous polymer positioned adjacent to a second side of the first composite region, the third region having a third hydrophobicity that exceeds the first hydrophobicity; and
an end-sealing region disposed to encompass an end of the first composite region between the second and third regions.

43. The sorbent polymer composite article of claim 42, wherein the end-sealing region is formed by pinching the second region and the third region together.

44. The sorbent polymer composite article of claim 42, wherein the end-sealing region is an additional layer of sealing material placed onto the sorbent polymer composite article, and wherein the sealing material is the same as the porous polymer of the second region or the porous polymer of the third region.

45. (canceled)
